(19) United States
(12) Patent Application Publication
(10) Pub. No.: US 2018/0172260 A1
(43) Pub. Date: Jun. 21, 2018

(54) LUMINAIRE HOUSING ASSEMBLY

(71) Applicant: GE Lighting Solutions, LLC, East Cleveland, OH (US)

(72) Inventors: Bulcsu SIMONYI, Budapest (HU); Tamas VASARHELYI, Budapest (HU); Gabor OCSKO, Budapest (HU); Tamas KANIZSA, BUdapest (HU)

(21) Appl. No.: 15/384,338

(22) Filed: Dec. 20, 2016

(51) Int. Cl. F21V 29/83; F21V 23/00; F21V 15/01; F21V 5/04

(52) U.S. Cl. CPC F21V 29/83; F21V 5/04; F21V 15/01; F21V 23/003

(57) ABSTRACT

A luminaire housing assembly includes an outer side wall extending between a lower end and an opposite upper end. The side wall is shaped to extend around a perimeter of one or more light generating devices of a luminaire. The housing assembly also includes a base plate coupled with the upper end of the side wall. The base plate includes vent openings for convection of heat generated by the one or more light generating devices out of a volume encircled by the side wall, wherein the side wall is joined to the base plate by a press fit connection.

### BACKGROUND

Luminaires generate light in a variety environments. The light sources in the luminaires also generate heat. Some types of light sources are equipped with heat sinks in order to provide the appropriate performance in terms of lumen output, while avoiding thermally damaging the luminaires. Some luminaires have forced ventilation (e.g., fans) to assist in carrying heat away from the light sources. Using separate heatsinks with or without forced ventilation can provide the cooling needed for the light sources to generate the appropriate performance of the luminaires. But, these additional components add to the overall size of the luminaires. These additional components also add additional potential points of failure to the luminaires.

### BRIEF DESCRIPTION

In one embodiment, a luminaire housing assembly is provided. The housing assembly includes an outer side wall extending between a lower end and an opposite upper end. The side wall is shaped to extend around a perimeter of one or more light generating devices of a luminaire. The housing assembly also includes a base plate coupled with the upper end of the side wall. The base plate includes vent openings for convection of heat generated by the one or more light generating devices out of a volume encircled by the side wall, wherein the side wall is joined to the base plate by a press fit connection.

In another example, a luminaire housing assembly is provided that includes an outer side wall shaped to extend around a perimeter of one or more light generating devices of a luminaire. The housing assembly also includes a base plate coupled with the side wall by engaging the side wall at an interface between the base plate and the side wall. The interface between the base plate and the side wall is free of one or more other materials.

In one embodiment, a method is provided that includes obtaining an outer side wall shaped to extend around a perimeter of one or more light generating devices of a luminaire, obtaining a base plate having one or more vent openings, and press-fitting the base plate and the side wall together at an interface. The interface between the base plate and the side wall is free of one or more other materials.

### BRIEF DESCRIPTION OF THE DRAWINGS

The present inventive subject matter will be better understood from reading the following description of non-limiting embodiments, with reference to the attached drawings, wherein below:

FIG. 1 illustrates one embodiment of a luminaire system;

FIG. 2 is an exploded view of one of the luminaire assemblies shown in FIG. 1 according to one example;

FIG. 3 is a cross-sectional view of a housing assembly of the luminaire assembly shown in FIG. 1 according to one example; and

FIG. 4 illustrates a flowchart of one embodiment of a method for forming a housing assembly of a luminaire assembly.

### DETAILED DESCRIPTION

One or more embodiments of the inventive subject matter described herein provide for luminaire housing assemblies and associated methods that integrate effective heat dissipation for an internal light source via the external surface of the housing and/or a vented internal surface of the housing in a mechanically protective and resistant housing enclosure. The housing may be formed from a one-piece part or body, or may be formed from multiple parts or bodies. In one embodiment, the single-piece body or multiple piece body of the housing is formed without fastening components or without welding, soldering, and/or applying an adhesive to join the pieces together.

To provide the cooling needed without adding a heat sink, the housing enclosure can be thermally conductive and have sufficient surfaces to dissipate the heat generated by light sources into the environment. The housing enclosure optionally may be designed to have sufficient airflow of the cooling surfaces in the enclosure. To realize these features, the housing may be formed entirely of a thermally conductive material (such as aluminum), and the multiple pieces of the housing may be connected to each other using metal-to-metal press fitting or press joints. This allows for heat to easily spread throughout the entire volume in the housing with the entire external and internal surfaces of the housing operating as cooling surface.

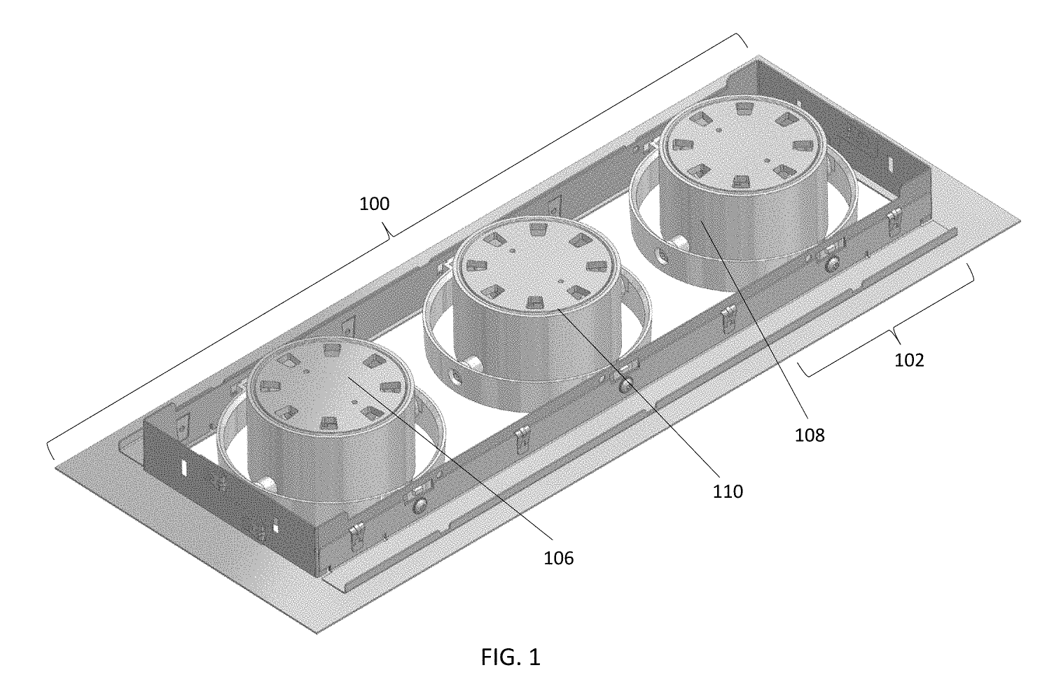

FIG. 1 illustrates one embodiment of a luminaire system 100. The luminaire system 100 includes plural luminaire assemblies 102 connected with each other. The illustrated luminaire assemblies 102 may be recessed lighting devices that are disposed inside a panel (e.g., a ceiling). Optionally, the luminaire assemblies 102 may be another type of lighting device. While FIG. 1 shows the system 100 including three luminaire assemblies 102, optionally, the system 100 may include a different number of one or more of the luminaire assemblies 102. Each of the luminaire assemblies 102 includes one or more light generating devices (not visible in FIG. 1) that generate light that emits from the luminaire assemblies 102. These light generating devices also generate heat. The light generating devices can include light emitting diodes (LEDs), fluorescent lights, or the like.

The luminaire assemblies 102 include housing assemblies 104 in which the light generating devices are disposed. The housing assemblies 104 provide a partial enclosure for the light generating devices that can provide an aesthetically pleasing appearance while protecting the light generating devices and transferring heat away from the light generating devices. The housing assemblies 104 can each be formed as a single piece body. For example, the housing assemblies 104 may be formed from a single piece of metal or metal alloy (e.g., aluminum or another metal) that is formed into the shape shown in FIG. 1, such as by casting the housing assembly 104, die-casting the housing assembly 104, forging the housing assembly 104, etc.

Optionally, the housing assemblies 104 can each be formed from two or more bodies. For example, the housing assemblies 104 can be formed from two or more bodies 106, 108 having a connection 110 that joins the bodies together. This connection 110 can be an interface that does not include the presence of any additional components, materials, or bodies. In one embodiment, the connection 110 may be a press-fit connection that does not include any adhesives, seals, or other materials other than the bodies 106, 108 forming the housing assembly 104. This can provide for a more thermally conductive housing assembly 104 as the heat generated by the light generating devices can flow from one body 106 to the other body 108 and out of the luminaire assembly 102 without the thermal conduction of the heat being reduced by one or more intervening materials between the bodies 106, 108. Optionally, the connection 110 may be a welded connection, a soldered connection, a connection formed by riveting, a connection formed by fasteners through the bodies of the housing assembly 104, etc.

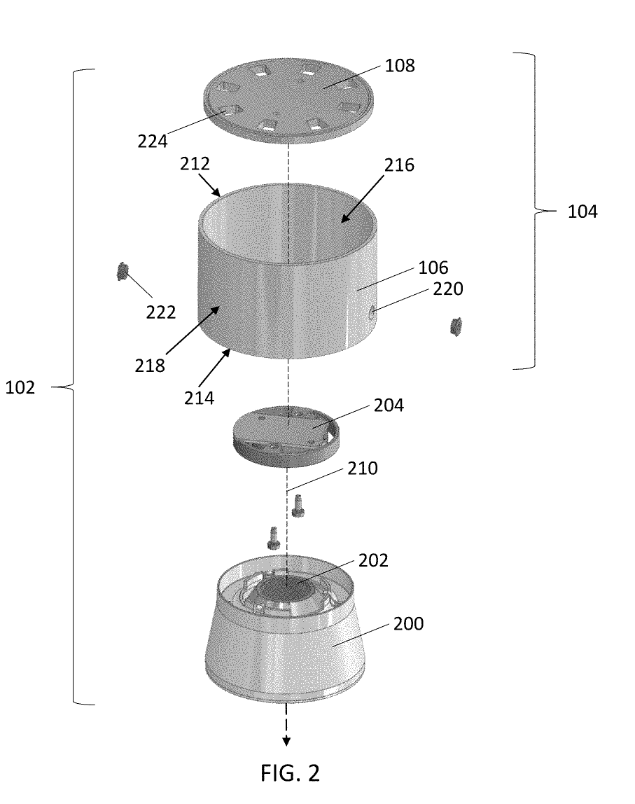

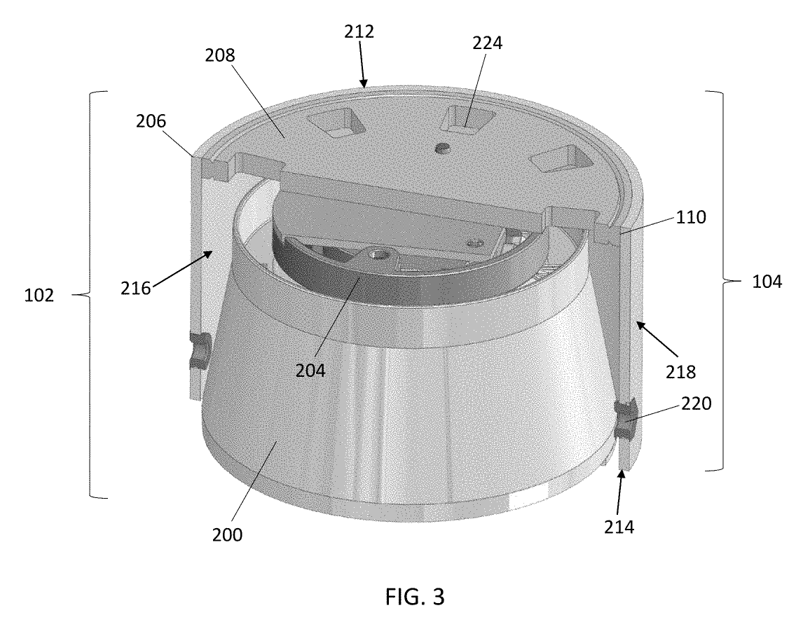

FIG. 2 is an exploded view of one of the luminaire assemblies 102 shown in FIG. 1 according to one example. FIG. 3 is a cross-sectional view of the housing assembly 104 of the luminaire assembly 102 shown in FIG. 1 according to one example. The luminaire assembly 102 includes an optic device 200, such as one or more lenses that focus or direct the light generated by one or more light generating devices 202 of the luminaire assembly 102. A driver device 204 includes hardware circuitry that control the conduction of current from an external source (e.g., a utility grid or the like) to the light generating devices 202. In one embodiment, the driver device 204 is not a heat sink. For example, the driver device 204 may include circuitry and/or other components that are not more thermally conductive than metal or a metal alloy, silicon, or the like. The optic device 200, the light generating device(s) 202, and the driver device 204 are disposed within the housing assembly 104.

In the illustrated embodiment, the housing assembly 104 is formed from plural bodies, such as an outer side wall 106 and a base plate 108. The outer side wall 106 has a cylindrical shape in FIG. 2, but optionally may have another shape (e.g., conical, frusto-conical, square, etc.). The outer side wall 106 extends along an axial direction or along an optical axis 210 of the luminaire assembly 102 from an upper end 212 to an opposite lower or light-emitting end 214. The outer side wall 106 extends around or encircles an outer perimeter of the light generating devices 202, the optic device 200, and/or the driver circuitry 204.

The outer side wall 106 has an inner surface 216 that faces the light generating devices 202, the optic device 200, and/or the driver circuitry 204, and has an opposite, outer surface 218 that may be visible outside of the luminaire system 100. The side wall 106 may include openings 220 for fasteners 222 to extend through. In the illustrated embodiment, the inner surface 216 is a smooth, continuous surface that does not include gaps, holes (e.g., other than the openings 220), ribs, inwardly extending protrusions, or the like. Alternatively, the inner surface 216 can include one or more gaps, holes, ribs, inwardly extending protrusions, or the like.

The base plate 108 has a complementary shape to that of the side wall 106. For example, the base plate 108 may have a circular shape to fit into the upper end 212 of the side wall 106, as shown in FIG. 3. The base plate 108 engages the side wall 106 at the connection interface 110 that may be a press-fit connection or other connection free of other bodies or materials. As shown in FIG. 3, the connection 110 is free of any other components, such as adhesives, seals, welds, or the like. The base plate 108 may be formed of the same thermally conductive material as the outer side wall 106 to assist in conducting heat away from the light generating devices 202.

The base plate 108 may be a planar body in that the base plate 108 has larger outer dimensions in two directions or dimensions (e.g., two different directions that are perpendicular to the optical axis 210) than in a third direction (e.g., the optical axis 210). The base plate 108 may not extend down into the interior space surrounded by the side wall 106 any further than the thickness of the base plate 108, as shown in FIG. 3. For example, the base plate 108 may not include any extensions that protrude down into the interior of the side wall 106.

The base plate 108 can include vent openings 224 that extend through the entire thickness of the base plate 108. The vent openings 224 can assist or allow for convection of heated air in the interior of the housing assembly 104 to pass through the vent openings 224 and out of the housing assembly 104 and luminaire assembly 102.

In operation, the light generating devices 202 create light that is emitted from the luminaire assembly 102. These light generating devices 202 also generate heat. The heat is conducted from the light generating devices 202 (and/or the air between the light generating devices 202 and the side wall 106) to the side wall 106 and/or base plate 108. Because the side wall 106 and base plate 108 are formed from thermally conductive materials, the heat may be conducted to locations outside of the housing assembly 104. Additionally, the vent openings 224 in the base plate 108 allow air to flow through the housing assembly 104 via convection without the use or addition of a fan or other air-moving device. This also aids in transferring the heat from the light generating devices 202 out of the housing assembly 104.

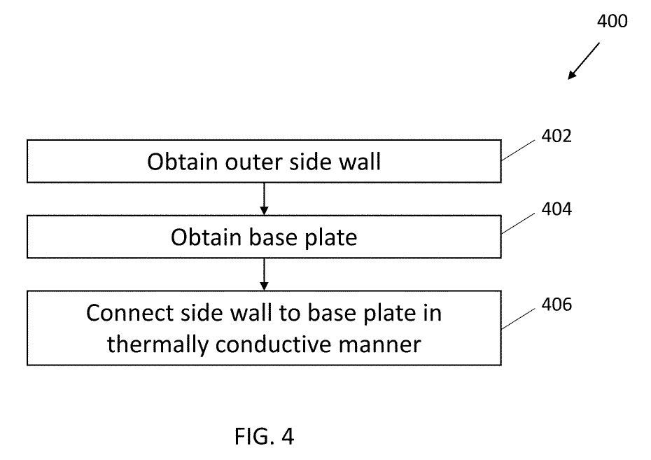

FIG. 4 illustrates a flowchart of one embodiment of a method 400 for forming a housing assembly of a luminaire assembly. The method 400 may be used to manufacture or otherwise provide the housing assembly 104 described herein. At 402, an outer side wall is obtained. This side wall may form part of the outer enclosure of the housing assembly. The side wall may have a tubular shape or other shape that encircles the light generating devices of the luminaire assembly that will include the housing assembly. At 404, a base plate is obtained. This base plate may have a shape that fits onto one end of the side wall. The side wall and the base plate may be obtained as separate bodies. For example, the base plate and side wall may be separately cut from the same or different pieces of metal or metal alloy.

At 406, the side wall and the base plate are connected with each other in a thermally conductive manner. For example, the side wall and base plate may be press-fit together to provide for a metal-on-metal contact between the side wall and base plate, with no other bodies or materials between the side wall and base plate. This can provide for improved thermal conductivity at the interface between the side wall and base plate relative to other connections between the side wall and base plate.

The housing assemblies described herein provide for more compact housings than other luminaires due to the absence of an additional heat sink for the light generating devices, while still providing appropriate cooling performance by the materials of and interface between the side wall and base plate providing good thermal conductivity and large dissipative surfaces. The vent openings in the base plate allow for internal convective ventilation so that no forced ventilation is needed.

As used herein, an element or step recited in the singular and proceeded with the word “a” or “an” should be understood as not excluding plural of said elements or steps, unless such exclusion is explicitly stated. Furthermore, references to “one embodiment” of the presently described subject matter are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the subject matter set forth herein without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose several embodiments of the subject matter set forth herein, including the best mode, and also to enable a person of ordinary skill in the art to practice the embodiments of disclosed subject matter, including making and using the devices or systems and performing the methods. The patentable scope of the subject matter described herein is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A luminaire housing assembly comprising:
an outer side wall extending between a lower end and an opposite upper end, the side wall shaped to extend around a perimeter of one or more light generating devices of a luminaire; and
a base plate coupled with the upper end of the side wall, the base plate including vent openings for convection of heat generated by the one or more light generating devices out of a volume encircled by the side wall, wherein the side wall is joined to the base plate by a press fit connection.

2. The luminaire housing assembly of claim 1, wherein the side wall has a smooth inner surface that faces the one or more light generating devices.

3. The luminaire housing assembly of claim 1, wherein the side wall is joined to the base plate without one or more adhesives or sealing materials in an interface between the side wall and the base plate.

4. The luminaire housing assembly of claim 1, wherein the base plate is a planar body.

5. The luminaire housing assembly of claim 1, wherein the base plate is a circular body.

6. The luminaire housing assembly of claim 1, wherein the side wall is shaped to encircle the one or more light generating devices.

7. The luminaire housing assembly of claim 1, wherein the side wall and the base plate engage each other at an interface that extends around the base plate without one or more other materials disposed between the side wall and the base plate.

8. A luminaire housing assembly comprising:
an outer side wall shaped to extend around a perimeter of one or more light generating devices of a luminaire; and
a base plate coupled with the side wall by engaging the side wall at an interface between the base plate and the side wall, wherein the interface between the base plate and the side wall is free of one or more other materials.

9. The luminaire housing assembly of claim 8, wherein the side wall extends between a lower end and an opposite upper end, and wherein the base plate is coupled with the upper end of the side wall.

10. The luminaire housing assembly of claim 8, wherein the side wall and the base plate are coupled with each other by a press fit connection.

11. The luminaire housing assembly of claim 8, wherein the base plate includes vent openings for convection of heat generated by the one or more light generating devices out of a volume encircled by the side wall.

12. The luminaire housing assembly of claim 8, wherein the side wall has a smooth inner surface that faces the one or more light generating devices.

13. The luminaire housing assembly of claim 8, wherein the base plate is a planar body.

14. The luminaire housing assembly of claim 8, wherein the base plate is a circular body.

15. The luminaire housing assembly of claim 8, wherein the side wall is shaped to encircle the one or more light generating devices.

16. The luminaire housing assembly of claim 8, wherein the side wall and the base plate are a single body.

17. A method comprising:
obtaining an outer side wall shaped to extend around a perimeter of one or more light generating devices of a luminaire;
obtaining a base plate having one or more vent openings; and
press-fitting the base plate and the side wall together at an interface, wherein the interface between the base plate and the side wall is free of one or more other materials.

18. The method of claim 17, wherein the side wall extends between a lower end and an opposite upper end, and wherein the base plate is press-fit with the upper end of the side wall.

19. The method of claim 17, further comprising cutting the one or more vent openings in the base plate.

20. The method of claim 17, further comprising placing the one or more light generating devices within a volume encircled by the side wall.
